(19) United States
(12) Patent Application Publication
(10) Pub. No.: US 2013/0084804 A1
(43) Pub. Date: Apr. 4, 2013

(54) Communication Terminal Having a Monitor Provided with a Transparent Antenna and Corresponding Method

(71) Applicant: Eric Fouchard, Bruz (FR)

(72) Inventor: Eric Fouchard, Bruz (FR)

(73) Assignee: SAS TAZTAG, Bruz (FR)

(21) Appl. No.: 13/580,321

(22) PCT Filed: Feb. 22, 2011
(86) PCT No.: PCT/EP2011/052598

§ 371 Date: Dec. 10, 2012

(30) Foreign Application Priority Data
Feb. 22, 2010 (FR) 1051266

(51) Int. Cl. H04B 7/24; H04B 5/00

(52) U.S. Cl. CPC H04B 7/24; H04B 5/00
USPC 455/41.1; 455/41.2

(57) ABSTRACT

A terminal comprises at least one monitor, capable of rendering image data, and radio frequency communication means for communicating with at least one additional communicating device. Said monitor supports, on at least one portion of the surface thereof, a transparent antenna which does not interfere with rendering said image data, and which works in cooperation with said radio frequency communication means. Said terminal comprises data generation means indicating the presence of said antenna, forming a portion of said image data rendered by said monitor.

### CROSS-REFERENCE TO RELATED APPLICATIONS

This Application is a Section 371 National Stage Application of International Application No. PCT/EP2011/052598, filed Feb. 22, 2011 and published as WO 2011/101488 A1 on Aug. 25, 2011, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

None.

### BACKGROUND OF THE DISCLOSURE

The field is that of terminals capable of contact-free communication with at least one other communicating device, by radio frequency, and, in particular, but not exclusively, by short-range, NFC-type communications.

These may be small portable terminals, such as, for example, portable telephones, PDAs or touch pads, or large devices, as the case may be stationary, such as televisions, interactive terminals, and so on.

Such devices are equipped with communication means, enabling the receipt and/or transmission of data signals to be controlled. These means conventionally cooperate with one or more antennas.

There are a very wide variety of antenna types. One of the problems of implementing antennas is that, to be effective, they must not be masked or disturbed by electromagnetic radiation, coming in particular from the electronic means provided in the terminal. This often presents problems of installing the antenna inside the device, and can lead to an increase in bulk.

It is also known to place the antenna outside the terminal, but this may be detrimental in terms of aesthetics, design, bulk, solidity and durability of the device.

In addition, in particular for the implementation of short-range communications, for example of the NFC or RFID type, it is desirable for the position of the antenna on the terminal to be easily identifiable, so that the user of another communicating device can approach the latter at several centimeters from the antenna. This is in particular the case when the terminals are large, such as a television, an interactive terminal, an automated gas pump, a cash dispensing or payment terminal, a window display, and so on.

Again, it is necessary to place the antenna outside the terminal, with the disadvantages mentioned above.

In addition, the antennas must be not only effective, but also inexpensive to produce and assemble, and have minimal bulk and weight.

### SUMMARY

A terminal comprises at least one screen, capable of rendering image data, and radio frequency communication means with at least one other communicating device. According to some embodiments, said screen has, on at least a portion of its surface, at least one transparent antenna, not disrupting the rendering of said image data, and cooperating with said radio frequency communication means, and said terminal comprises data generation means indicating the presence of said antenna, forming a portion of said image data rendered by said screen.

Thus, according to some embodiments, it is possible to set an antenna on the screen, without it disrupting the broadcasting of images. However, the presence and location of the antenna may be indicated permanently or as necessary, and, as the case may be, in a personalized manner. This is in particular useful for short-range communications, for example of the NFC type, for which it is necessary to get close to the communicating device.

In other words, some embodiments combine two aspects that are, in principle, contradictory: the optically transparent, i.e. invisible, character of the antenna, and the possibility of seeing, if not the antenna, at least its location.

According to a particular embodiment, said transparent antenna is produced by depositing a conductive material with a density and/or thickness so that they do not disrupt the trajectory of the light rays emitted by said screen.

It can, for example, be a silver and titanium deposit. Said transparent antenna can in particular be formed on a transparent film brought back on said screen.

This film may be adhesive, and brought back on the screen, on its face directed outwardly, or on its face directed inwardly toward the terminal.

In some cases, said transparent film can also perform a function of protecting said screen and/or of touch detection.

Said radio frequency communication means can ensure at least short-range communications, for example of the NFC type.

Such communications require, according to the adjustments and powers used, the two communicating devices not to be separated by more than several centimeters or dozens of centimeters. The possibility of knowing the location of the antenna, in particular on large terminals, is then beneficial.

Said radio frequency communication means can also ensure at least ZigBee®, Bluetooth® and/or Wi-Fi communications.

When the two types of communication are available, it may be possible to initiate communication via NFC, and to continue it with another communication mode, allowing greater distances and/or higher rates.

In one embodiment, said data generation means indicating the presence of the antenna may or may not generate a presence indicator on the basis of at least one predetermined criterion.

It is thus possible to control, and/or personalize, the display. When the indicator is not necessary, or is undesired, it is not present. In this case, the antenna is perfectly invisible, and the information rendered by the screen is not modified. When the indicator is useful, it is inserted in the images (depending on the case, at the source or in the terminal).

Said predetermined criterion or criteria may in particular belong to the group including:
the availability of data to be transmitted from the terminal to at least one other communicating device;
the detection of the presence of a person nearby;
the detection of the presence of at least one other communicating device nearby;
the identification of at least one other communicating device nearby;
a time range or a remaining duration;
the activation of a particular function on said terminal.

In addition, said indicator may be different and/or variable on the basis of said criterion or criteria.

For example, the color or the intensity may change according to the closeness of the communicating device or a remaining time, or be personalized according to the user (or the category of the user, such as his or her belonging to a group, a family, a company, an age group, etc.).

The indicator may comprise text and/or a logo, and/or an animated sequence broadcast by said screen under and/or in the vicinity of said transparent antenna.

Embodiments can in particular be implemented in the terminals belonging to the group including:
televisions;
computer screens;
portable terminals, such as radio-navigation devices, personal assistances, audio and/or video file readers, data exchange and storage terminals;
portable telephones;
screens on-board vehicles;
automated devices such as gas pumps;
public communication terminals, implanted, for example, in airports, bus depots, tourist information offices, stores;
payment terminals;
window displays.

Some embodiments also relate to a method for checking at least one terminal according to certain embodiments, comprising at least one screen, capable of rendering image data, and means for radio frequency communication with at least one other communicating device.

Such a method comprises the following steps:
determining a need to display the presence and/or location of a transparent antenna on said screen, not disrupting the rendering of said image data, and
generating data indicating the presence of said antenna, forming a portion of said image data rendered by said screen.

According to a particular embodiment, the method also comprises a step of:
obtaining and/or generating information to be delivered via said antenna, on the basis of the content rendered on said screen and/or at least one data item relating to the holder of said other communicating device.

Other features and advantages will become clearer in view of the following description of a particular embodiment, provided by way of a simple illustrative and non-limiting example, and appended drawings.

### BRIEF DESCRIPTION OF THE DRAWINGS

FIG. 1 diagrammatically shows a terminal according to one embodiment;

FIGS. 2A, 2B and 2C show three alternative embodiments, and are side views of the terminal of FIG. 1;

FIG. 3 is a simplified synoptic diagram of the terminal of FIG. 1.

### DETAILED DESCRIPTION

Embodiments propose a new approach to implement antennas on communicating terminals equipped with a screen. Indeed, the antenna necessary for data exchanges with one or more other communicating devices is ensured by means of a transparent antenna, produced by depositing a conductive material on the screen, or on a transparent surface covering this screen. Also according to some embodiments, the presence of this antenna is indicated, or signaled, permanently or selectively, by means of suitable information (for example, a logo and/or an animation).

Thus, an antenna is obtained simply and effectively, placed on the screen without altering the broadcasting of information and images rendered by this screen. In addition, although the antenna itself is transparent and therefore invisible, its presence and/or its location on the terminal may be known to a user equipped with another communicating device.

This is useful in particular in the case of short-range communications, of the NFC type (conventionally several centimeters).

In addition, as will be seen below, the signaling may be selective, and adapted as necessary, according to various criteria.

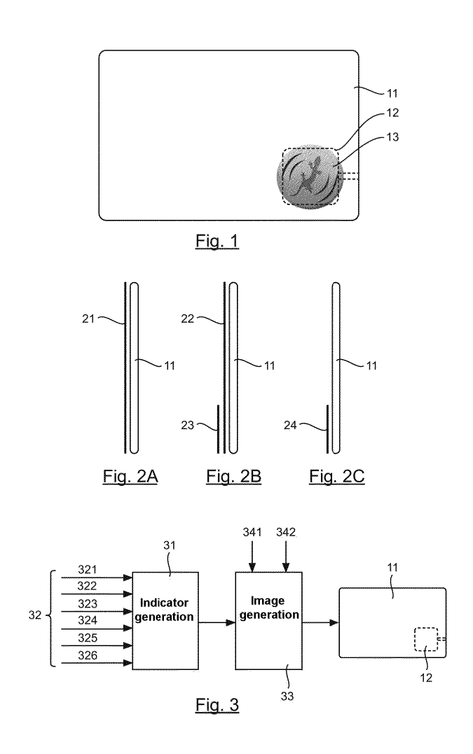

As seen in FIG. 1, which diagrammatically shows an example of a terminal according to some embodiments (in this case, a storage and data exchange terminal, developed by the applicant, and already described in patent document FR-2 935 572).

This terminal has, on its front face, a touch screen 11, enabling images and/or text to be displayed, and information to be entered.

A transparent antenna 12 (and for this reason shown with a dotted line) is placed in the lower right-hand corner of the screen 11 (the position and surface of the antenna are of course non-restrictive, since it is invisible).

Means are provided for inserting, in the images rendered by the screen 11, information 13 such as a logo or an animation, indicating the presence and/or activation of the antenna 12. This indication may be displayed permanently or as necessary, and, if need be, may be variable according to the conditions.

The transparent antenna 12 is produced by depositing a conductive material, with a low enough density and/or thickness so as not to disrupt the transparency of its support. According to some embodiments, this support may be as shown diagrammatically in FIGS. 2A to 2C:
directly a film 21 or a transparent surface of the screen, as shown in FIG. 2A, with this film also being capable of providing a touch detection function and/or a screen protection function;
a plastic film 22 brought back, for example, adhesively, on the touch detection film 23, as shown in FIG. 2B;
a film 24, for example, adhesive, brought back directly on the screen, as shown in FIG. 2C.

In other words, the antenna may be formed directly on a transparent element that is already part of the terminal, or on a separate support, for example self-adhesive, so as to then be brought back on the screen or one of its protection or touch detection surfaces.

A technique making it possible to produce such an antenna is, for example, described in the document “Optically transparent monopole antenna with high radiation efficiency manufactured with silver grid layer (AgGL)” (Hautcoeur J. et al, Electronics letters, 2009, vol. 45, no. 20, pp. 1014-101), incorporated by reference. This technique proposes producing a double silver/titanium mesh layer printed on a transparent support such as glass.

Another technique is, for example, described in patent document U.S. Pat. No. 5,872,542 (incorporated by reference), proposing different materials for producing a transparent antenna.

According to a simplified embodiment, the antenna presence indication may be permanent. For example, as shown in FIG. 1, the logo 13 appears permanently under the antenna 12.

According to another approach, the display of this indication may be controlled by the terminal. As shown in the simplified diagram of FIG. 3, the terminal includes means 31 for generating the indicator on the basis of criteria 32. According to these criteria, the generation means 31 control the presence or absence of the logo 13 on the screen 11, and, if need be, its modification or adaptation. Diagrammatically, the image to be rendered is generated by means 33 provided for this purpose, for example, on the basis of data 341 received from a microprocessor and/or from a received video signal 342, also taking into account commands or signals generated by the means 31.

Thus, when it is not necessary, the logo is not visible, and nothing (i.e. neither the logo nor the antenna) disrupts the image rendering and/or information on the screen 11.

According to a first criterion 321, the display of the logo 13 (or more generally an animation, or an indication, indicating the presence of the antenna) may be activated when the terminal has information to be transmitted to another communicating device. It is indeed possible, according to the embodiments, for the terminal, at a given time, to have information to be transmitted, while, at other times, it does not have any. In this latter case, it is of course not necessary to display the presence of the antenna.

This situation may, for example, be encountered when the terminal responds to a request by the user. Thus, for example, in the case of an interactive terminal of a car dealership, the user was able to choose a particular vehicle on a touch screen. The interactive terminal then provides the corresponding catalogue and signals it by indicating the presence and location of the antenna. In this application, in particular, the duration of availability may be limited, and, in this case, the indicator may vary, for example, by flashing, changing color or dimming so as to signal that the remaining time is short.

Similarly, for example, in a department store, the presence of the antenna may be signaled once information relating to a promotion is available.

According to yet another example, associated with a broadcast, for example televised or via the Internet, information may be available according to the content of a video signal 322 emitted. Thus, during an advertisement, the announcer may preview the provision of information downloadable on a communicating device via an NFC connection, in the form of an advertising complement, a discount coupon, etc.

It may also be possible to link such an advertising system with the broadcast of a film (for example: displaying the indicator when the product appears in the film or during and/or after broadcasting of an advertising message), or to download information such as a telephone number or the address of a website broadcast on the screen. In every case, the broadcaster, or the program designer, may control the antenna presence indicator, so that it is visible at the desired moment. This may be done either by suitable signaling, which the terminal receives and decodes, and then processes, via the generation means 31, or directly by an indicator integrated in the image signal, if it is agreed that the antennas are still placed in the same location on the set of terminals.

The activation of the indicator 13 may also be dependent on the detection 323 of a communicating device nearby. Thus, when no device is near the terminal, the image rendering and information on the screen is not disrupted. However, when a user gets near the terminal, with a communicating device, for example by NFC, the terminal may display the indicator so as to signal that it is capable of communicating, and incite the user to place his or her communicating device nearby.

In this case, again, the display may be variable in terms of colors, flashing, intensities or verbal or numerical indications, so as to incite the user to pull up his or her communicating device (for example, the indicator may be red when it detects the communicating device but the latter is too far for an effective exchange, and green when the latter is close enough).

According to another embodiment, the device may detect the presence of a person nearby, for example by means of at least one infrared or ultrasound sensor, and then activate the indicator 13. The presence detector may also be used to start the broadcast of a film or a message.

The display of an indicator may also be associated with an identification of the holder of the communicating device. For example, if the communicating device is or includes a fidelity card, the indicator will be displayed if this fidelity card is recognized and valid. It may also be an authorization to access information, for example via a subscription. For example, if the user has subscribed to an electronic journal, he or she may download it from a terminal, of which the indicator will be visible. It is also possible in this case to provide a variable display, for example a red indicator if the user is not subscribed, a green indicator if the user is subscribed, and an orange indicator if the subscription period is reaching its end.

The identification may also be more personal, in order to personally recognize the carrier, and therefore display a personalized indicator (for example, with a name, alias or photo of him) and, if need be, also consequently adapt the content of the information that can be downloaded via the antenna. It is also possible to take into account the user's membership in an identified group (family, leisure, professional, regional, etc.) and/or a criterion associated with the user (age, sex, family situation, areas of interest, language, etc.).

The information may in particular be made available according to one of the techniques described in patent document WO 2010136582.

Another criterion 325 may be a time-based criterion. Thus, an interactive terminal or a gas dispensing terminal, for example, may be accessible on certain days or at certain times of day, and not at other times. In this case, the antenna presence indicator indicates this availability. According to an approach similar to that proposed above, it is also possible to provide information made available, for example promotions for short periods. During this, the indicator is activated.

Finally, the manager of the terminal may himself or herself control (326) the activation or non-activation of the indicator.

Of course, these different criteria may be combined, so as to activate and/or personalize or adapt the indicator. Embodiments may be implemented on numerous types of screens according to needs and applications. In particular, it can be implemented on:
televisions;
computer screens;
portable terminals, such as radio-navigation devices, personal assistants, audio and/or video file readers, data exchange and storage terminals;
portable telephones;
screens on-board vehicles;
automated devices, such as gas pumps;
public communication terminals, implanted, for example, in airports, bus depots, tourist information offices, stores;
payment terminals;
window displays, equipped with image broadcasting means.

In some cases, it is possible to provide a plurality of antennas on the same screen, in particular if it is large. This may enable, according to the embodiments:
simultaneous access to multiple people, or facilitated access regardless of the position of the person with respect to the screen;
the delivery of different information according to the antenna (one antenna being dedicated to women, the other to men, for example, or to subscribers and non-subscribers of a service, or to any choice proposed on the screen, etc.);
a fun or random implementation, with the active antenna varying on the screen;
etc.

In some embodiments, the antenna may be at least partially in the vicinity of the display area, in an edge of the screen. In this case, the indication of the location of the antenna on the screen may be adapted, for example by means of an arrow.

It is also possible for the antenna to be active only when it is necessary (and therefore signaled according to an embodiment), or permanently.

Some embodiments relate to a method for controlling a terminal as described above, controlling in particular the generation of data indicating the presence of the antenna.

This method includes in particular a step of determining a need to display the presence and/or the location of the antenna and a step of activating the data display, according to a command generated by the determination step.

This determination step takes into account, according to the embodiments, one or more information items, as detailed above, so as to generate a command that may be of the “all or nothing” type, or variable (variable flashing, selection of one antenna among several, etc.).

The method may also include a step of obtaining information to be delivered via the antenna. This information may be obtained in “push” mode (the information is provided in a multimedia content on the screen, or associated with it), or in “pull” mode (selected from a server, for example, according to data obtained via the device to which this information must be transferred).

Although the present disclosure has been described with reference to one or more examples, workers skilled in the art will recognize that changes may be made in form and detail without departing from the scope of the disclosure and/or the appended claims.

1. A terminal comprising:
at least one screen, capable of rendering image data, and radio_frequency communication means capable of communicating with at least one other communicating device,
characterized in that said screen has, on at least a portion of its surface, at least one transparent antenna, not disrupting the rendering of said image data, and cooperating with said radio_frequency communication means, and
characterized in that said terminal comprises data generation means indicating the presence of said antenna, forming a portion of said image data rendered by said screen.

2. The terminal according to claim 1, characterized in that said transparent antenna is produced by depositing a conductive material with a density and/or thickness so that they do not disrupt the trajectory of the light rays emitted by said screen.

3. The terminal according to claim 2, characterized in that said transparent antenna is formed on a transparent film brought back on said screen.

4. The terminal according to claim 3, characterized in that said film is adhesive.

5. The terminal according to claim 3, characterized in that said transparent film also performs a function of protecting said screen or of touch detection.

6. The terminal according to claim 1, characterized in that said radio_frequency communication means ensure at least short-range communications, for example of the NFC type.

7. The terminal according to claim 1, characterized in that said radio_frequency communication means ensure at least one of ZigBee®, Bluetooth® and/or Wi-Fi communications.

8. The terminal according to claim 1, characterized in that said data generation means indicating the presence of the antenna generates a presence indicator on the basis of at least one predetermined criterion.

9. The terminal according to claim 8, characterized in that said predetermined criterion or criteria in particular belong(s) to the group including:
the availability of data to be transmitted from the terminal to at least one other communicating device;
the detection of the presence of a person nearby;
the detection of the presence of at least one other communicating device nearby;
the identification of at least one other communicating device nearby;
a time range or a remaining duration; and
the activation of a particular function on said terminal.

10. The terminal according to claim 8, characterized in that said indicator is different on the basis of at least one criterion.

11. The terminal according to claim 1, characterized in that said image data comprises an animated sequence broadcast by said screen in the vicinity of said transparent antenna.

12. The terminal according to claim 1, characterized in that it belongs to the group including:
televisions;
computer screens;
portable terminals, such as radio-navigation devices, personal assistances, audio file readers, video file readers, data exchange and storage terminals;
portable telephones;
screens on-board vehicles;
automated devices such as gas pumps;
public communication terminals, implanted, for example, in airports, bus depots, tourist information offices, stores;
payment terminals; and
window displays.

13. A method executed by at least one terminal, comprising at least one screen, capable of rendering image data, and means for radio_frequency communication with at least one other communicating device, characterized in that it comprises the following steps:
determining a need to display the presence and/or the location of a transparent antenna on said screen, not disrupting the rendering of said image data, and
generating data indicating the presence of said antenna, forming a portion of said image data rendered by said screen.

14. The method according to claim 13, characterized in that it also comprises a step of:
obtaining information to be delivered via said antenna, on the basis of the content rendered on said screen or at least one data item relating to the holder of said other communicating device.
